(19) United States
(12) Patent Application Publication
(10) Pub. No.: US 2026/0085717 A1
(43) Pub. Date: Mar. 26, 2026

(54) Plugs, Wood-Concrete Composite Element and Process

(71) Applicant: Adolf Wirth GmbH & Co. KG, Kunzelsau (DE)

(72) Inventors: Dennis RÖVER, Kunzelsau (DE); Udo CERA Udo CERA, Schwabisch Hall (DE)

(21) Appl. No.: 19/337,476

(22) Filed: Sep. 23, 2025

(30) Foreign Application Priority Data
Sep. 26, 2024 (DE) 102024127924.9

(51) Int. Cl. F16B 41/00

(52) U.S. Cl. CPC F16B 41/005

(57) ABSTRACT

The invention relates to a plug for use in a wood-concrete composite element, wherein the plug is provided for placing onto the head of a screw which is provided for screwing into a wooden element of the wood-concrete composite element, wherein the plug is designed to at least partially engage around a periphery of a screw head, and/or wherein the plug is designed to engage with a drive formation of the screw.

The invention relates to a plug for use in a wood-concrete composite element, wherein the plug is provided for placing onto the head of a screw which is provided for screwing into a wooden element of the wood-concrete composite element. The invention also relates to a wood-concrete composite element. The invention also relates to a method for producing a wood-concrete composite element and to a method for dismantling a wood-concrete composite element.

Wood-concrete composite elements are known. Usually, screws are screwed perpendicularly or obliquely into a wooden ceiling. Then a concrete layer is applied to the wooden ceiling and completely encloses the screw heads of the screws. After the concrete has solidified, the screws serve to transmit shear forces between the wooden ceiling and the concrete layer. The problem with such conventional wood-concrete composite elements is that they cannot be readily recycled in such a way that the individual constituent parts, in particular the metal screws, the concrete of the concrete layer and the wooden ceiling, can be separated in a simple manner.

The invention intends to improve a plug, a wood-concrete composite element, a method for producing a wood-concrete composite element and a method for dismantling a wood-concrete composite element.

For this purpose, the invention provides a plug having the features of Claim 1, a wood-concrete composite element having the features of Claim 13, a method for producing a wood-concrete composite element having the features of Claim 18, and a method for dismantling a wood-concrete composite element having the features of Claim 19. Advantageous developments of the invention will be apparent from the subclaims.

In the case of a plug for use in a wood-concrete composite element, wherein the plug is provided for placing onto the head of a screw which is provided for screwing into a wooden element of the wood-concrete composite element, provision is made for the plug to be designed to at least partially engage around a periphery of a screw head and/or to engage with a drive formation of the screw.

If the plug is designed to at least partially engage around a periphery of a screw head, the plug then bears partially against a bottom side of the screw head and is fixed to the screw head as a result. Within the scope of the invention, it is expedient for the majority of the bottom side of the screw head to remain free and therefore be contacted directly by the concrete layer. In this way, reliable transmission of shear forces between the wooden element and the concrete layer is possible, this transmission of shear forces being brought about mainly via the bottom side of the screw head against which the concrete layer bears.

In a development of the invention, the plug has a cutout with an at least partially undercut periphery for receiving the periphery of the screw head.

The plug advantageously consists of flexible and/or elastic material. The partially undercut periphery of the plug can be latched onto the periphery of the screw head. If the plug engages around the periphery of the screw head, this simultaneously ensures that the screw can be unscrewed from the concrete layer together with the plug or after the plug has been removed. This is because the depression in the concrete layer, which is formed by the plug and proceeds from the top side of the concrete layer, then has an inner diameter which is slightly greater than or at least the same size as an outer diameter of the screw head of the screw.

Also if the plug is designed to engage with a drive formation of the screw, the plug can be securely fastened to the screw head. Within the scope of the invention, the plug may both at least partially engage around a periphery of a screw head and engage with a drive formation of the screw. For example, the plug is provided with a stud for plugging into a drive formation on the screw head or the plug has a ring for plugging onto a hexagonal head of a screw.

In a development of the invention, the plug has, in a wall of the cutout, a circumferential predetermined breaking edge.

This makes it possible to facilitate the removal of the plug if the latter is embedded with its circumferential wall in the concrete layer. When being removed from the screw head, the plug breaks into two parts or two portions at the predetermined breaking edge. The portion located above the predetermined breaking edge can be easily removed from the concrete layer, and the portion located below the predetermined breaking edge remains in the concrete layer and can be removed for example after the screw has been unscrewed.

In a development of the invention, the predetermined breaking edge is adjacent to the undercut periphery for receiving the periphery of the screw head.

As a result, the largest possible part of the plug can be removed during the removal from the concrete layer and only that portion of the plug which is located below the screw head and possibly also radially outside the periphery of the screw head remains in the concrete layer.

In a development of the invention, the plug has a stud which can be plugged into a drive formation of the screw.

In this way, the plug can be fastened to a screw having a hexagonal socket or a multilobular socket in a very simple manner.

Such a stud can also ensure that the concrete that is still liquid when the concrete layer is applied does not flow into the drive formation the screw and thereby soils it and makes the unscrewing of the screw, which is carried out when dismantling the wood-concrete composite element, difficult or impossible.

In a development of the invention, the plug has a length which is dimensioned in such a way that the plug in the finished wood-concrete composite element extends as far as a top side of a concrete layer of the wood-concrete composite element.

By virtue of the plug in the finished wood-concrete composite element extending as far as a top side of a concrete layer of the wood-concrete composite element, the plug can be reliably identified on the finished wood-concrete composite element. When the wood-concrete composite element is intended to be dismantled, it is therefore easy to identify the position of the screws. Either before the plug is removed or still with the plug fastened to the screw, it is then possible to unscrew the screw from the wooden element and the concrete layer, in order to thereby have the possibility, when dismantling a wood-concrete composite element, of separating wooden elements, the concrete layer and the screws in a simple manner and of being able to dispose of them separately.

In a development of the invention, the plug is formed in one piece and from an elastic material, in particular rubber or rubber-like material.

Such a one-piece plug consisting of elastic material can be removed from the concrete layer in a very simple manner when dismantling a wood-concrete composite element. This is because the elasticity of the plug allows it to detach from the concrete layer and to be able to be pulled out. This also applies if the screw is removed from the solidified concrete layer together with the plug.

In a development of the invention, the plug is of cylindrical or truncated-cone-shaped design.

Advantageously, the plug has a circular cross section and is thus of circular cylindrical or circular truncated-cone-shaped design. A truncated-cone-shaped plug creates a cutout in the concrete layer, said cutout widening from the screw head up to the top side of the concrete layer. This facilitates the unscrewing of the screw when dismantling a wood-concrete composite element.

In a development of the invention, a top side of the plug is arranged obliquely with respect to a bottom side, in particular the plug has the form of an obliquely cut circular cylinder or of an obliquely cut circular truncated cone.

In this way, it is possible for screws screwed obliquely into a wooden element of a wood-concrete composite element to also be provided with a plug, which greatly simplifies the dismantling of the wood-concrete composite element since the screws can be unscrewed from the wooden element and the concrete layer in a very simple manner, and the top side thereof is arranged flush with the top side of the concrete layer.

In a development of the invention, the plug has a passage opening or a cutout, wherein, when the plug has been placed onto a screw, a drive formation of the screw is accessible through the passage opening or through the cutout.

This makes it possible for the screw to be screwed in or unscrewed with the plug placed thereon, making the handling considerably easier. For example, screws can be delivered with a plug placed thereon already, with the result that the placing-on of the plug at the construction site can be omitted.

In a development of the invention, a stopper or a cap is provided, in order to close the passage opening or the cutout.

After the screw has been screwed into the wooden element, it is therefore possible for the passage opening or the cutout to be sealed in order to prevent liquid concrete or other impurities from passing into the drive formation of the screw when the concrete layer is applied.

In a development of the invention, an inlet opening of the passage opening or of the cutout is closed by means of a predetermined breaking point or a membrane.

If, for example, the plug is placed on after the screw has been screwed in, the predetermined breaking point or the membrane ensures that when the concrete layer is applied no liquid concrete passes into the drive formation of the screw and thereby possibly makes it unusable. The predetermined breaking point is arranged in a continuous top side of the plug or the membrane is part of a continuous top side of the plug. It is only when the screw is intended to be unscrewed or screwed in even further that the membrane or the predetermined breaking point is pushed through and in so doing partially destroyed, for example with a screwdriver bit.

In a development of the invention, the plug is constructed as a hollow body.

In this way, only a little material is required for the production of the plug.

In a development of the invention, at least one marking lug or gripping piece proceeds from a top side of the plug and extends beyond a top side of the concrete layer in the installed state.

In this way, the plugs can be identified even more easily on the finished wood-concrete composite element. This is because even if a top side of the plug were to be covered by a thin concrete layer, for example because the intended thickness of the concrete layer was exceeded slightly, the marking lug or the gripping piece still projects beyond the top side of the concrete layer. The gripping piece, for example a gripping stud or a gripping strip, also facilitates the removal of the plug when the wood-concrete composite element is intended to be dismantled.

The object on which the invention is based is also achieved by a wood-concrete composite element, in particular a wood-concrete composite ceiling, having a wooden element, at least one screw screwed into the wooden element, a plug placed onto a screw head of the screw, and a concrete layer which rests on a top side of the wooden element and extends beyond a head of the screw, wherein the cylindrical or truncated-cone-shaped plug is fastened to the head of the screw, wherein an outer diameter of the plug as far as a top side of the plug is greater than or the same size as an outer diameter of the screw head, and wherein the plug extends as far as a top side of the concrete layer.

Ideally, the top side of the plug is arranged flush with the top side of the concrete layer. The wood-concrete composite element can therefore usually be provided with a floor covering and especially be dismantled in a very simple manner by the screws being unscrewed from the wooden element and the concrete layer, before or after the plugs have been removed, in order to be able to dispose of or recycle the screws, the plugs, the wooden element and the concrete layer separately.

In a development of the invention, a marking lug or a gripping piece proceeds from a top side of the plug, said top side facing away from a head of the screw, and extends beyond a top side of the concrete layer.

It is therefore possible for the position of the screws to be determined in a very simple manner on the finished wood-concrete composite element, even if the concrete layer were to cover the top side of the plug because the concrete layer was produced slightly thicker than intended. A gripping piece makes the removal of the plugs considerably easier. For example, the gripping piece is gripped by hand or with pliers and the plug can then be removed in a very simple manner, with the result that the drive formation of the screw is accessible from the top side of the concrete layer.

In a development of the invention, the plug has a passage opening or a cutout, wherein a drive formation of the screw is accessible through the passage opening or the cutout, and wherein an inlet opening of the passage opening or cutout, which is arranged in the top side of the plug, is arranged flush with a top side of the concrete layer.

By way of such a passage opening or cutout, the drive formation of the screw can be reached, for example with a screwdriver bit. The screwing-in and unscrewing of the screw is therefore possible without any problems even with a placed-on plug.

In a development of the invention, the inlet opening of the passage opening or cutout is closed by means of a cap or a stopper.

This makes it possible to ensure that when the concrete layer is applied the liquid concrete does not run into the drive formation of the screw, which could make the subsequent unscrewing of the screw impossible.

In a development of the invention, the inlet opening of the passage opening or cutout is provided with a predetermined breaking point or a membrane.

The inlet opening of the passage opening or cutout is therefore reliably closed and, after the stopper has been placed onto the screw head, it is possible to ensure that also no liquid concrete passes into the drive formation of the screw when the concrete layer is applied.

The object on which the invention is based is also achieved by a method for producing a wood-concrete composite element, in which the following steps are provided: screwing at least one screw into a top side of a wooden element, in particular of a wooden ceiling, of the wood-concrete composite element, placing a plug onto a screw head of the at least one screw and applying a concrete layer to a top side of the wooden element, such that the concrete layer extends as far as a top side of the plug.

The plug can be placed onto the screw head before the screw is screwed in, but the plug may alternatively be placed onto the screw head after the screw has been screwed in. The plug can be removed without any problems after the concrete layer has solidified, with the result that a drive formation in the screw head is therefore accessible from the top side of the concrete layer. For example, the plug consists of elastic material and can therefore be removed easily from the solidified concrete layer. A truncated-cone-shaped design of the plug, such that the plug widens from the screw head towards its top side, can also facilitate the removal of the plug.

The object on which the invention is based is also achieved by a method for dismantling a wood-concrete composite element, in which the following steps are provided: unscrewing at least one screw from the wooden element of the wood-concrete composite element after the plug has been removed from the concrete layer and from the screw head of the screw, unscrewing the at least one screw from the wooden element and simultaneously removing the plug from the concrete layer or unscrewing the at least one screw through the passage opening of the plug and then removing the plug from the concrete layer and, after the screw has been unscrewed and the plug has been removed from the concrete layer, separating the concrete layer from the wooden element.

The method according to the invention makes it possible to recycle a wood-concrete composite element in a very simple manner in such a way that wood, concrete, the plugs and the screws are separate and can therefore also be recycled separately.

Further features and advantages of the invention emerge from the description of preferred embodiments of the invention in conjunction with the drawings. Individual features of the different embodiments which are presented and described can be combined with one another in any desired manner without going beyond the scope of the invention. This also applies to the combination of individual features without further individual features in conjunction with which they are presented and/or described. In the drawings:

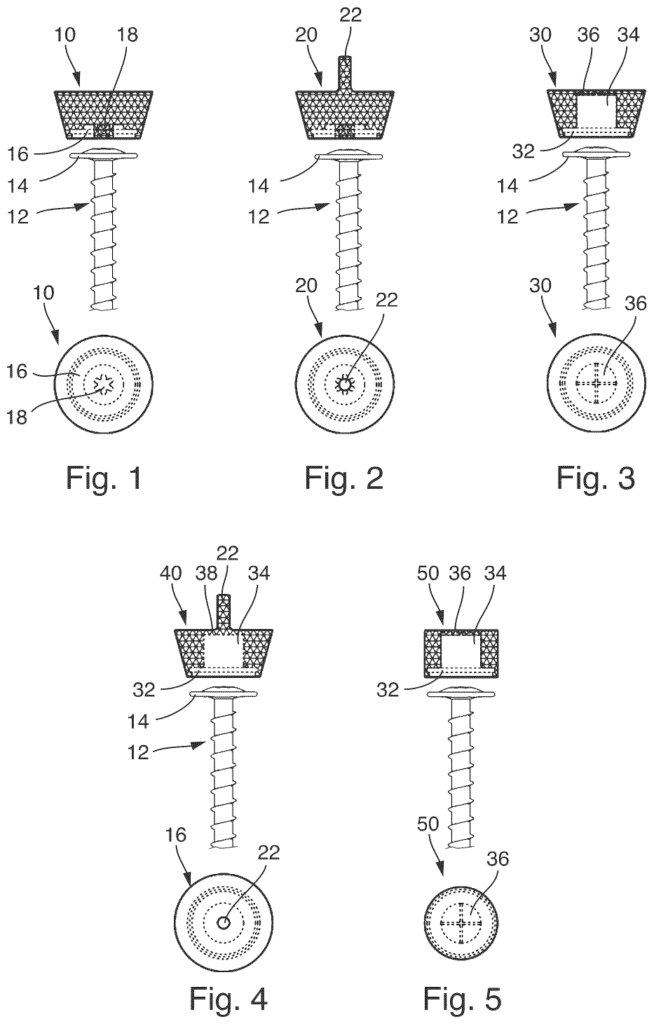

FIG. 1 shows a top view and a sectional view of a plug according to a first embodiment of the invention together with a partially illustrated screw,

FIG. 2 shows a top view and a sectional view of a plug according to a second embodiment of the invention together with a partially illustrated screw,

FIG. 3 shows a top view and a sectional view of a plug according to a third embodiment of the invention together with a partially illustrated screw,

FIG. 4 shows a top view and a sectional view of a plug according to a fourth embodiment of the invention together with a partially illustrated screw,

FIG. 5 shows a top view and a sectional view of a plug according to a fifth embodiment of the invention together with a partially illustrated screw,

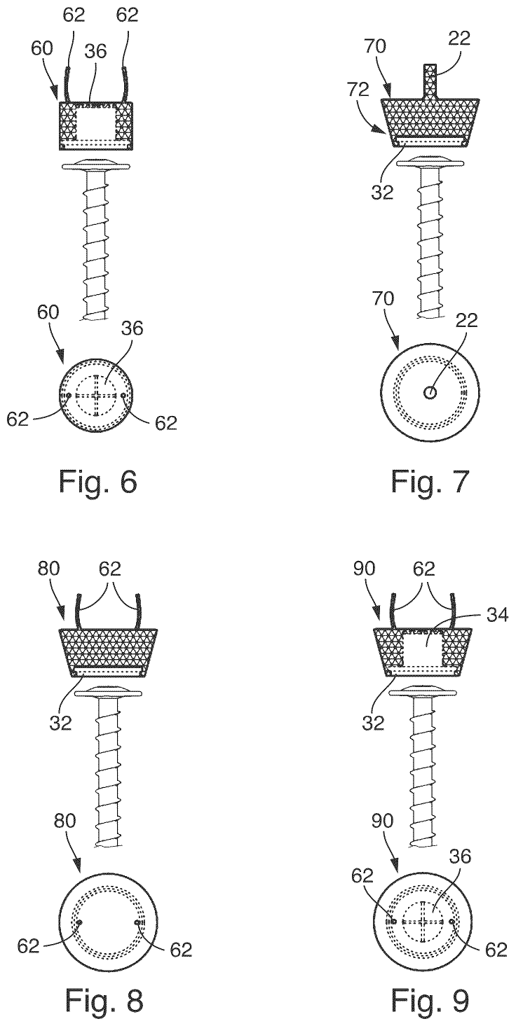

FIG. 6 shows a top view and a sectional view of a plug according to a sixth embodiment of the invention together with a partially illustrated screw,

FIG. 7 shows a top view and a sectional view of a plug according to a seventh embodiment of the invention together with a partially illustrated screw,

FIG. 8 shows a top view and a sectional view of a plug according to an eighth embodiment of the invention together with a partially illustrated screw,

FIG. 9 shows a top view and a sectional view of a plug according to a ninth embodiment of the invention together with a partially illustrated screw,

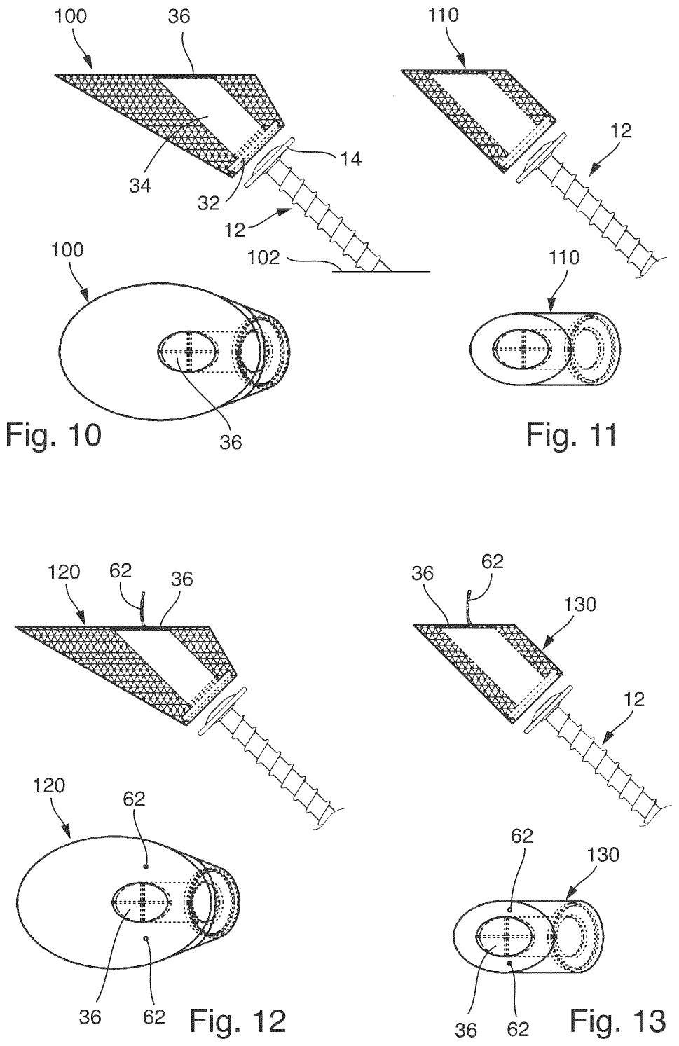

FIG. 10 shows a top view and a sectional view of a plug according to a tenth embodiment of the invention together with a partially illustrated screw,

FIG. 11 shows a top view and a sectional view of a plug according to an eleventh embodiment of the invention together with a partially illustrated screw,

FIG. 12 shows a top view and a sectional view of a plug according to a twelfth embodiment of the invention together with a partially illustrated screw,

FIG. 13 shows a top view and a sectional view of a plug according to a thirteenth embodiment of the invention together with a partially illustrated screw,

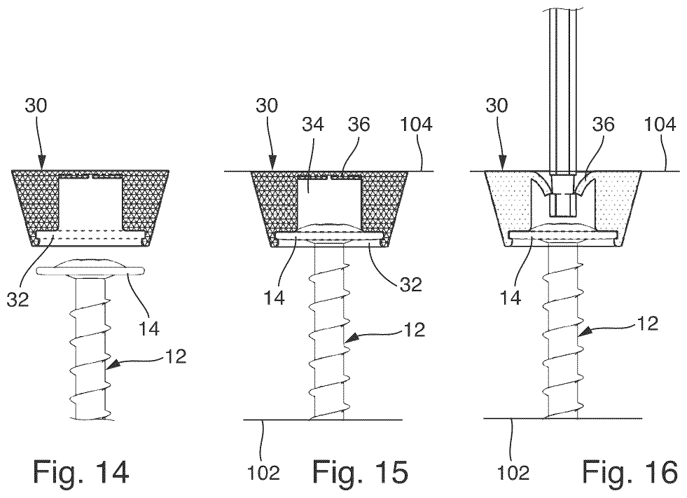

FIG. 14 shows a sectional view of the plug in FIG. 3 before the placing onto the screw head of a screw,

FIG. 15 shows the plug in FIG. 14 after the placing onto the screw head of the screw,

FIG. 16 shows the plug in FIG. 15 after a screwdriving tool has been inserted into the plug,

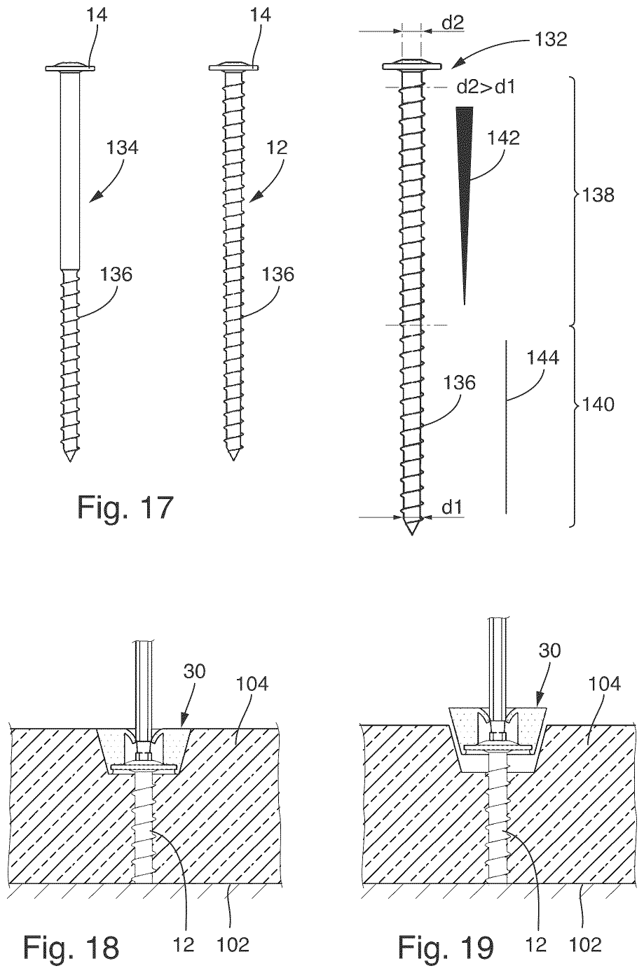

FIG. 17 shows various screws which are suitable for a wood-concrete composite element according to the invention,

FIG. 18 shows the plug in FIG. 16 in a wood-concrete composite element according to the invention, after the screwdriving tool was inserted into the drive formation of the screw,

FIG. 19 shows the plug and the wood-concrete composite element in FIG. 18, after the screwdriving tool was used to unscrew the screw to some extent already,

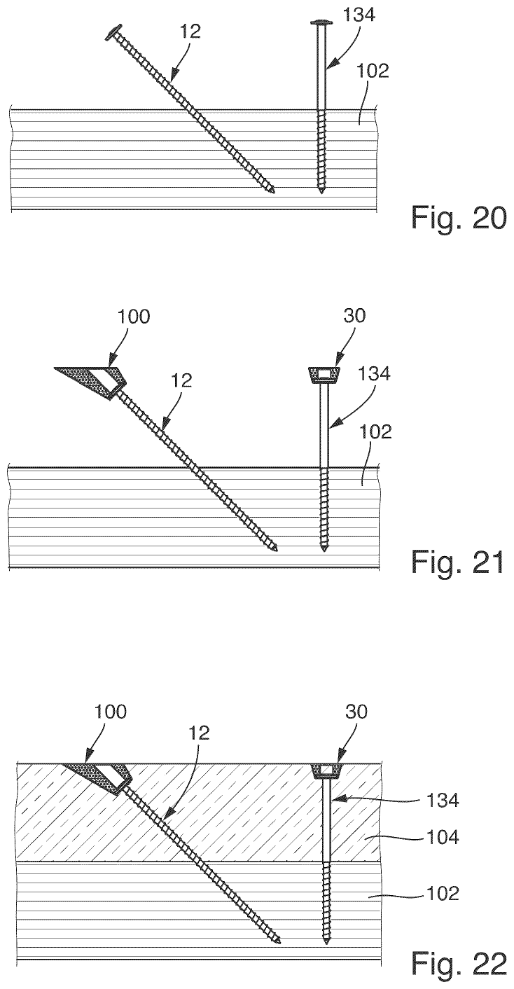

FIGS. 20, 21 and 22 show various steps in the production of a wood-concrete composite element according to the invention,

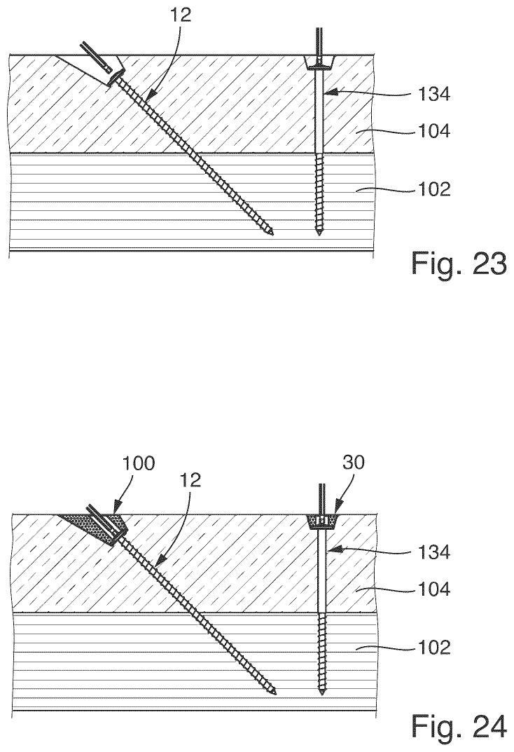

FIG. 23 shows a first possibility when dismantling a wood-concrete composite element according to the invention,

FIG. 24 shows a second possibility when dismantling a wood-concrete composite element according to the invention,

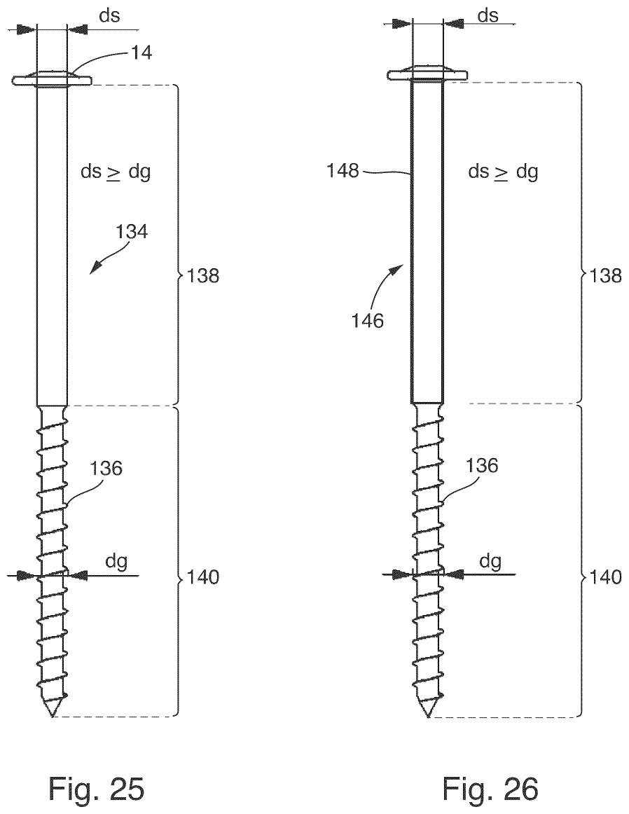

FIG. 25 shows a screw for a wood-concrete composite element, and

FIG. 26 shows a further screw for a wood-concrete composite element.

FIG. 1 shows a top view of a plug 10 according to the invention according to a first embodiment of the invention and also a sectional view of the plug 10. Below the sectional view of the plug 10, a screw 12 is partially illustrated and has a screw head 14 onto which the plug 10 can be placed.

In order to be able to place the plug 10 onto the screw head 14, the bottom side of the plug 10 is provided with a cutout 16 of stepped design. A first step of the cutout has an inner diameter which is smaller than an outer diameter of the periphery of the screw head 14. A second step has an inner diameter which corresponds to or is slightly smaller than the outer diameter of the periphery of the screw head 14. The first step forms the opening of the cutout 16, and the second step adjoins the first step. The first step and the second step therefore form an undercut or a circumferential, radially inwardly projecting protrusion on the bottom side of the plug 10. A third step of the cutout has a considerably smaller inner diameter than the first and the second step and is provided to receive an upwardly curved top side of the screw head. A stud 18 proceeds from the base of the cutout 16 and extends as far as an inlet opening of the cutout in the bottom side of the plug 10. This stud 18 has an outer contour which is matched to the inner contour of the drive formation in the screw head 14. In the embodiment illustrated, the stud 18 has the form of a multilobular head which can be plugged into the multilobular socket of the drive formation in the screw head 14.

When the plug is moved from the position above the screw illustrated in FIG. 1 towards the screw head 14, the radially inwardly projecting periphery of the cutout 16 snaps over the periphery of the screw head 14. The periphery of the screw head 14 is then received in the second step of the cutout 16. The radially inwardly projecting periphery on the bottom side of the plug 10 engages around the periphery of the screw head 14, with the result that the undercut between the first step and the second step of the cutout 16 thus bears against the bottom side of the screw head. The plug 10 is therefore already securely fastened to the screw head 14. At the same time, when the plug 10 is placed onto the screw head 14, the stud 18 is pressed into the drive formation in the screw head 14. This additionally secures the plug on the screw head 14. The top view of the plug 10 in FIG. 1 shows the various steps of the cutout 16 with dashed lines and also the stud 18 in dashed lines.

It can be seen in the sectional view in FIG. 1 that the top side of the plug 10 is of planar design. After the plug has been placed onto the screw head 14, in the production of a wood-concrete composite element, a liquid concrete layer is applied to the wooden element, such that a top side of the concrete layer is arranged flush with a top side of the plug 10. After the concrete has solidified, the top side of the plug 10 is therefore visible in the concrete layer. To remove the plug, the latter can be removed from the concrete layer and from the screw head 14 in a simple manner. The plug consists of rubber or rubber-like material and is therefore elastic. This facilitates the latching of the plug 10 onto the periphery of the screw head 14 and also enables the simple removal of the plug 10 from the screw head 14. The removal of the plug 10 from the concrete layer is also facilitated by the plug 10 having the form of a circular truncated cone and widening from the bottom side illustrated at the bottom in the sectional view in FIG. 1 towards the top side. After the plug 10 has been removed, a truncated-cone-shaped depression is thus accessible in the concrete layer. This truncated-cone-shaped depression makes it possible to easily reach the drive formation of the screw 12 in the screw head 14 with a screwdriving tool and the screw 12 can then be unscrewed from the wooden element and the concrete layer. It is also essential that the plug 10 prevents, when a concrete layer is applied, liquid concrete from passing into the drive formation of the screw 10 and thereby preventing or complicating the unscrewing of the screw 14.

FIG. 2 shows a top view and a sectional view of a plug 20 according to a further embodiment of the invention. The plug 20 is largely constructed in the same way as the plug 10 in FIG. 1 and only the features of the plug 20 that differ from the plug 10 will be described below.

The top side of the plug 20 has a gripping portion 22 or a gripping piece, which projects upwards from the top side of the plug 20. The gripping portion 22 is arranged centrally with respect to the top side of the plug 20 and has the form of a circular-cylindrical protrusion.

In a finished wood-concrete composite element, a top side of the concrete layer is arranged flush with a top side of the plug 20. The gripping portion 22 then projects beyond the top side of the concrete layer. The plug 20 can then be gripped at the gripping portion 22 and be removed from the concrete layer and from the screw head 14 of the screw 12 in a simple manner. The gripping portion 22 is approximately as long as the distance from the bottom side of the plug 20 to the top side of the plug 20.

FIG. 3 shows a top view and a sectional view of a plug 30 according a third embodiment of the invention. The plug 30 is constructed as a hollow body and has a two-stepped cutout proceeding from the bottom side of the plug, the two steps of which are of identical design to the first two steps of the cutout 16 of the plug 10 in FIG. 1. As explained with reference to FIG. 1, this cutout 32 makes it possible for the plug 30 to be placed onto the periphery of the head 14 of the screw 12.

The cutout 32 continues in a further, cylindrical cutout 34 which has a smaller diameter than the cutout 32. The cutout 34 goes to just below the top side of the plug 30 and ends at a membrane 36 which (see the top view in FIG. 3) is provided with a predetermined breaking point depicted in dashed form in the top view. The predetermined breaking point is realized by means of two lines which are arranged in the form of a cross and at which the material thickness of the membrane 36 is significantly reduced.

The plug 30 in FIG. 3 is latched onto the periphery of the screw head 14 only after the screw 12 has been screwed into a wooden element. The plug 30 therefore sits tightly on the periphery of the screw head 14 and also, due to the membrane 36, no liquid concrete can enter the hollow space 34 when producing the concrete layer, since the bottom side of this cutout 34 is closed by the screw head 14 and the top side is closed by the membrane 36. The concrete layer is applied in such a way that it extends as far as the top side of the plug 30, that is to say that the top side of the plug 30 and thus also the top side of the membrane 36 are arranged aligned or flush with the top side of the concrete layer.

If the screw 12 is intended to be unscrewed when dismantling a wood-concrete composite element, the membrane 36 is pierced with a screwdriving tool. The screwdriving tool can then engage in the drive formation in the screw head 14. The screw 14 can then be unscrewed together with the plug 30 from the wooden element and also from the concrete layer. The truncated-cone-shaped design of the plug 30, which widens from its bottom side to its top side, facilitates the unscrewing of the screw 12 together with the plug 30 from the concrete layer.

FIG. 4 shows a top view and a sectional view of a plug 40. Like the plug 30 in FIG. 3, the plug 40 has the cutout 32 which forms an undercut and is used to latch the plug 40 onto the screw head 14 of the screw 12. Like in the case of the plug 30 in FIG. 3, the cutout 32 is adjoined by the hollow space 36. The hollow space 36 is closed towards the top side of the plug 40, not with a membrane but rather by means of a cover 38 arranged flush with the top side of the plug 40. Concentrically with respect to the top side of the plug 40, a cylindrical gripping portion 22 projects out of the cover 38, which has already been explained on the basis of the plug 20 in FIG. 2.

The plug 40 is latched onto the periphery of the screw head 14 after the screw 12 has been screwed into a wooden element. Before the screw is unscrewed from the wooden element and the concrete layer, the plug 40 has to be removed in order to reach the drive formation in the screw head 14. The truncated cone shape of the plug 40 facilitates the removal of the plug 40 from the concrete layer.

FIG. 5 shows a plug 50 according to a fifth embodiment of the invention. The plug 50 has a cylindrical shape, more specifically a circular-cylindrical shape. The bottom side of the plug 50 is provided with the stepped cutout 32, which has already been explained on the basis of the plug 40 in FIG. 4. As in the case of the plug 40, the cutout 32 is continued by the cutout 34. The cutout 34 is closed towards the top side of the plug 50 by means of a membrane 36, the construction and function of which has already been explained on the basis of the plug 30 in FIG. 3.

FIG. 6 shows a top view and a sectional view of a plug 60 according to a sixth embodiment of the invention. The plug 60 is constructed very similarly to the plug 50 in FIG. 5, and only the features that differ from the plug 50 will be explained.

From the top side of the plug 60, two marking lugs 62 proceed from a region radially outside the membrane 36. The marking lugs 62 are produced from elastic material, for example rubber or rubber-like material, like the rest of the plug 60 and are produced in one piece with the plug 60. In a finished wood-concrete composite element, a top side of the concrete layer is flush with the top side of the plug 60. The marking lugs 62 project beyond the top side of the concrete layer and can therefore be easily identified. This also applies if the concrete layer were to extend slightly beyond the top side of the plug 60. Even in this case, the marking lugs 62, which are approximately as long as the distance from the bottom side of the plug 60 to the top side of the plug 60, project beyond the concrete layer.

FIG. 7 shows a plug 70 according to a seventh embodiment of the invention. The plug 70 has the cutout 32 which forms an undercut and has already been explained on the basis of the plug 30 in FIG. 3. With the exception of the cutout 32, the plug 70 is formed from solid material, for example rubber or rubber-like material. The gripping portion 22 extends from a top side of the plug 70, which has already been explained on the basis of the plug 20 in FIG. 2. In FIG. 7, a dashed line indicates the position of a predetermined breaking edge 72. The circumferential predetermined breaking edge 72 is arranged in the circumferential wall of the cutout 32 and adjoining the undercut periphery of the cutout 32. The material of the plug 70 is suitably weakened, for example of very thin embodiment or provided with a perforation, in the region of the predetermined breaking edge 72, such that when the plug 70 located in the concrete layer is pulled off from the screw head, the portion of the plug 70 that is located above the periphery of the screw head separates from the part of the plug 70 that is located below the periphery of the screw head. The plug 70 thus tears at the dashed line, that is to say at the predetermined breaking edge 72. The concrete layer which bears against the truncated-cone-shaped circumferential wall of the plug 70 is not illustrated in FIG. 7. The concrete layer prevents or makes it difficult for the portion of the plug 70 that is located below the screw head to be able to pass around the periphery of the screw head to the top side of the screw head. Instead, the plug 70 tears at the predetermined breaking edge 72. The portion of the plug 70 that is located above the screw head can therefore be removed from the concrete layer in a simple manner. After the partial removal of the plug 70, the drive formation in the screw head is then accessible from the top side of the concrete layer and the screw can be unscrewed. Such a predetermined breaking edge 72 can, for example, also be provided on the plugs 30, 40, 50, 60, 80, 90, 100, 110, 120, 130.

FIG. 8 shows a plug 80 according to an eighth embodiment of the invention. The plug 80 differs from the plug 70 in FIG. 7 merely in that, in the case of the plug 80, instead of the gripping portion 22 two marking lugs 62 are provided, which have already been explained on the basis of the plug 60 in FIG. 6.

FIG. 9 shows a plug 90 according to a ninth embodiment of the invention. The plug 90 differs from the plug 40 in FIG. 4 merely in that instead of the gripping portion 22 two marking lugs 62 proceed from the top side of the plug 90. The marking lugs 62 have already been explained on the basis of the plug 60 in FIG. 6.

FIG. 10 shows a top view and a sectional view of a plug 100 according to a tenth embodiment of the invention. The plug 100 differs from the plug 30 in FIG. 3 merely in that the plug 100 has the form of an obliquely cut circular truncated cone. The plug 100 is provided for being placed onto the screw head 14 of the screw 12 when the screw 12 has been screwed at an angle of 45° into a wooden element. The screw 12 in FIG. 10 has been screwed at an angle of 45° with respect to a schematically indicated wooden element 102.

The plug 100 has the cutout 32 which forms an undercut and is latched onto the periphery of the screw head 14 of the screw 12. When the plug is then rotated into the position illustrated in the sectional view in FIG. 10, a top side of the plug 100 is parallel to the top side of the wooden element 102. The top side of the plug 100 is therefore arranged at an angle of 45° with respect to its bottom side.

The cutout 32 is continued by the depression 34 which ends at the membrane 36 which closes the cutout 34 on the top side of the plug 100. The membrane 36 is provided with a predetermined breaking point in the form of two lines which are arranged in crosswise fashion and at which the material thickness of the membrane 36 is reduced.

Like the plug 30 in FIG. 3, the plug 100 is placed onto the screw head 14 after the screw 12 has been screwed into the wooden element 102. If the screw 12 is intended to be unscrewed from the wooden element 102 and the concrete layer of the finished wood-concrete composite element, the membrane 36 is pierced with a screwdriving tool until the screwdriving tool engages in the drive formation on the screw head 14. The screw 12 can then be unscrewed together with the plug 100.

FIG. 11 shows a plug 110 according to eleventh embodiment of the invention. The plug 110 differs from the plug 100 in FIG. 10 merely by its shape, which is not in the form of a truncated cone like in the case of the plug 100, but rather has the form of a circular cylinder cut at 45°. The top side of the plug 110 is arranged at an angle of 45° with respect to the bottom side of the plug 110. The plug 110 is also provided for placing onto screws which are screwed at 45° into the wooden element 102.

FIG. 12 shows a plug 120 according to a twelfth embodiment of the invention. The plug 120 differs from the plug 100 in FIG. 10 merely in that two marking lugs 62 proceed from a top side of the plug 120 radially outside the membrane 36. The shape and function of the marking lugs 62 have already been explained on the basis of the plug 60 in FIG. 6.

FIG. 13 shows a plug 130 according to a thirteenth embodiment of the invention. The plug 130 differs from the plug 110 in FIG. 11 merely in that two marking lugs 62 proceed from a top side radially outside the membrane 36. The shape and function of the marking lugs 62 have already been explained on the basis of the plug 60 in FIG. 6.

FIGS. 14, 15 and 16 show different method steps in the production and dismantling of a wood-concrete composite element. FIG. 14 illustrates a sectional view of the plug 30 in a state in which it has not yet been latched onto the periphery of the screw head 14 of the screw 12, which is merely partially illustrated. FIG. 14 readily shows the two-stepped cutout 32, which forms an undercut. Since the plug 30 consists of elastic material, for example rubber or rubber-like material, the plug 30 can be latched onto the periphery of the screw head 14 in a very simple manner.

FIG. 15 shows the state in which the plug 30 has been latched onto the periphery of the screw head 14 of the screw 12. It can be seen that the periphery of the screw head 14 is then arranged within the largest-diameter second step of the cutout 32, and that the periphery of the first step of the cutout 32 engages around the periphery of the screw head 14 and bears in the outermost peripheral region of the bottom side of the screw head 14 against the bottom side. The plug 30 is therefore fixed securely, but still detachably, to the screw head 14.

The membrane 36 closes the hollow space 34 towards the top side of the plug 30. If in the state in FIG. 15 a concrete layer 104 is then applied to the wooden element 102, so much concrete is applied that a top side of the concrete layer 104 is arranged flush or aligned with the top side of the plug 30. Even if liquid concrete were to pass onto the top side of the plug 30 during the application of the concrete layer, the hollow space 34 is reliably sealed against the ingress of liquid concrete. Towards the bottom side of the plug, the secure fit of the screw head 14 in the cutout 32 ensures sealing. Towards the top side, the membrane 36 seals the hollow space 34. This ensures that no liquid concrete can pass onto the screw head 14 and into the drive formation of the screw head 14 during the application of the concrete layer 104. The screw has been partially screwed into a wooden element 102, for example a wooden ceiling. There is a distance between a top side of the wooden element 102 and the bottom side of the screw head 14. The top side of a concrete layer 104, which is applied after the screw 12 has been screwed into the wooden element and after the plug 30 has been placed onto the screw 12, is indicated in FIG. 15. Liquid concrete is applied to the wooden element 102 until a top side of the concrete layer 104 is flush with the top side of the plug 30. After the concrete layer 104 has solidified, the wood-concrete composite element is finished and able to be subjected to load. The wood-concrete composite element can be produced on site at the construction site, but it may also be prefabricated or finished in a factory and then brought to a construction site.

FIG. 16 shows a finished wood-concrete composite element comprising the schematically indicated wooden element 102, into which the screw 12 has been screwed, and comprising the concrete layer 104, which surrounds the screw shank and extends as far as the top side of the plug 30.

In order to dismantle the wood-concrete composite element, the membrane 36 is pierced with a screwdriving tool, here with a screwdriver bit, such that the screwdriving tool can be inserted into the drive formation in the screw head 20. The screw 12 can then be unscrewed from the wooden element 102 and from the concrete layer 104 by rotation of the screwdriving tool. The plug 30 is simultaneously moved out of the concrete layer 104 during the unscrewing of the screw 12. The truncated cone shape of the plug 30 facilitates the removal of the plug 30 from the concrete layer 104.

FIG. 17 shows a side view of the screw 12 and two further screws 132 and 134. All the screws 12, 132, 134 are suitable for producing a wood-concrete composite element and each have a screw head 14 with a drive formation and a fastening thread 136. The screw 12 is in the form of a fully threaded screw and the fastening thread 136 extends from a tip of the screw as far as the bottom side of the screw head 14.

The screw 132 has a different design of the shank compared with the screw 12. The shank of the screw is in the form of a truncated cone in a first portion 138, which begins directly below the screw head, and tapers in a direction from the screw head to the screw tip. Directly below the screw head, the shank has a diameter d2 and this diameter d2 tapers in a stepped manner up to the end of the portion 138 to the diameter d1, which is smaller than the diameter d2. This is illustrated by the symbolic illustration 142. The portion 140 of the shank begins at the end H the portion 138 and goes as far as the screw tip. In the portion 140, the outer diameter of the shank remains constant at a value d1, with the exception of the region of the tapering screw tip. This is indicated by the symbolic line 144 of constant line thickness. In the installed state in a wood-concrete composite element, the portion 138 is arranged in the concrete layer and the portion 140 is arranged in the wooden element of the wood-concrete composite element. The screw 132 is also in the form of a fully threaded screw and the fastening thread 136 extends from a tip of the screw as far as the bottom side of the screw head 14. Within the scope of the invention, the at least partially tapering shank may also be provided on a partly threaded screw.

The screw 134 has a fastening thread 136 which does not extend as far as the bottom side of the screw head 14, but rather from the tip of the screw merely to approximately halfway along the length of the shank of the screw 134. From the screw-head-side end of the fastening thread 136 to the bottom side of the screw head 14, the shank of the screw 134 is smooth. An outer diameter in the smooth portion of the shank is greater than or equal to the outer diameter of the shank in the region of the fastening thread 136. As a result, the screw can be unscrewed from a finished wood-concrete composite element in a simple manner when the latter is intended to be dismantled.

FIG. 18 shows, in part, a wood-concrete composite element comprising a wooden element 102, for example a wooden ceiling, a screw 12 screwed into the wooden element 102, the plug 30 placed onto the head of the screw 12, and the concrete layer 104 which extends from the top side of the wooden element 102 as far as the top side of the plug 30.

FIG. 18 illustrates a state which follows after the state explained with reference to FIG. 16. The screwdriving tool has then been inserted so far into the plug 30 that the screwdriving tool engages in the drive formation of the screw 12.

FIG. 19 shows a state in which the screw 12 has already been unscrewed to some extent from the wooden element 102 and the concrete layer 104. This is effected by anticlockwise rotation of the screwdriving tool. It can be gathered from FIG. 19 that the plug 30, which is latched unchanged on the screw head of the screw 12, is also unscrewed from the concrete layer 104 simultaneously with the screw 12. A truncated-cone-shaped cutout and a bore extending as far as the wooden element 102 remain in the concrete layer 104 when the screw 12 has been completely unscrewed from the wooden element 102 and the concrete layer 104.

FIGS. 20 to 22 show three steps in the production of a wood-concrete composite element according to the invention.

In the state in FIG. 20, the screw 134, which has already been explained with reference to FIG. 17, has been screwed so far into the wooden element 102 that the fastening thread 136 is arranged completely within the wooden element 102 and only the smooth portion of the shank and the screw head are arranged above the wooden element 102. The screw 134 has been screwed perpendicularly into the top side of the wooden element 102.

The screw 12 has been screwed at an angle of 45° with respect to the top side of the wooden element 102 into the wooden element 102.

In FIG. 21, the plug 30 has been placed onto the head of the screw 134, which has already been explained with reference to FIG. 3 and FIGS. 14, 15, 16, 18 and 19. The plug 100 has been placed onto the head of the obliquely screwed-in screw 12, which has already been explained with reference to FIG. 10.

The top side of the plug 100, which has the form of an obliquely cut circular truncated cone, and the top side of the plug 30, which has the form of a circular truncated cone, are arranged aligned with one another in the state in FIG. 21. In order to correct the position of the top side of the plug 100, the plug 100 may possibly be removed from the screw 12 and the screw may be screwed a little further into the wooden element 102 or unscrewed a little further from the wooden element 102. Expediently, aids which make it possible to observe a predefined screwing-in depth for the screws 134 and 12 are used to screw in the screw 12 and possibly also to screw in the screw 134.

FIG. 22 shows the finished wood-concrete composite element. The concrete layer 104 has then been applied to the top side of the wooden element 102, so much liquid concrete having been applied that the top side of the concrete layer 104 is aligned with the top sides of the plugs 100 and 30.

Shear forces can then be transmitted between the concrete layer 104 and the wooden element 102 due to the fact that the concrete layer 104 both surrounds portions of the shanks of the screws 12, 134 and engages with the bottom side of the heads of the screws 12, 134. At the same time, the screws 12, 134 prevent the concrete layer 104 from lifting off from the wooden element 102.

FIG. 23 shows the wood-concrete composite element in FIG. 22 in a state in which the two plugs 100, 30 have already been removed and thus both the head of the screw 12 and the head of the screw 134 are accessible from the top side of the concrete layer 104. After the plugs 100, 30 have been removed, the top side of the head of the screw 12 is accessible via a cutout in the form of an obliquely cut circular truncated cone and the top side of the head of the screw 134 is accessible via a cutout in the form of a truncated cone in the concrete layer 104. FIG. 23 depicts screwdriving tools which can be inserted into the drive formations of the screws 12, 134 in order to unscrew the screws 12, 134 both from the wooden element 102 and from the concrete layer 104.

After the screws 12, 134 have been removed, the concrete layer 104 can be removed from the wooden element 102 when dismantling the wood-concrete composite element in FIG. 23. Overall, simple separation of the constituent parts of the wood-concrete composite element composed of different materials is possible, namely the plugs 100, 30 consisting of rubber or rubber-like material, the screws 12, 134 consisting of metal, the concrete layer 104 and the wooden element 102.

FIG. 24 shows a step when dismantling the wood-concrete composite element in FIG. 22 in a state in which the plugs 100, 30 have not been removed first. The respective membrane 36 of the plugs 100, 30 has been pierced with a screwdriving tool and, as a result, the screwdriving tool can engage in the drive formation on the head of the screws 12, 134. The screws 12, 134 are then removed together with the plugs 100, 30 from the wooden element 102 and the concrete layer 104.

FIG. 25 shows the screw 134 in FIG. 17 on an enlarged scale. Arranged below the screw head 14 is the first portion 138 of the shank of the screw 134, which is smooth. In this portion 138 of the shank of the screw, the shank has a diameter ds. In the portion 138, the shank of the screw is cylindrical.

The portion 138 is adjoined by the further portion 140 of the shank of the screw having the fastening thread 136. With the exception of the tapering screw tip, the shank is cylindrical and has a constant outer diameter dg in the portion 140. The screw 134 is designed in such a way that the diameter ds is greater than or equal to the diameter dg. In the portion 138, the shank of the screw is enclosed by the concrete layer in a wood-concrete composite element. In the portion 140, the screw 134 is screwed into the wooden element of the wood-concrete composite element. If the diameter ds is greater than or the same size as the diameter dg, when the screw 14 is unscrewed from the concrete layer, the portion 138 leaves behind a channel in the concrete layer, through which channel the portion 140 of the shank having the fastening thread 136 can also be unscrewed.

In the case of the screw illustrated in FIG. 25, the portions 138 and 140 are of approximately equal length. It is possible within the scope of the invention to deviate from this.

FIG. 26 shows a further screw 146 according to the invention which is provided in the region of the portion 138 with a sheath 148 of the shank of the screw. This sheath 148 is in the form of a cylindrical tube and is pushed onto the shank in the portion 138 or applied in some other way, for example sprayed thereon or applied by immersion. The sheath 148 may be in the form of a metal coating, a metal tube, a plastics tube or a plastics layer or some other layer. The intent and purpose of the sheath 148 is to bring the outer diameter ds of the shank in the region 138 to a greater value, such that the outer diameter ds is greater than or the same size as the outer diameter dd in the portion 140 of the shank of the screw 148. In the portion 140, the shank of the screw is provided with the fastening thread 136.

In a wood-concrete composite element, the portion 140 of the screw 148 is screwed into a wooden element and the portion 138 of the screw is embedded in a concrete layer. If the screw 148 is then unscrewed from the wood-concrete composite element, the portion 138 leaves behind a channel in the concrete, the inner diameter of said channel being greater than or the same size as the outer diameter dg of the shank of the screw in the portion 140. The screw 148 can therefore be unscrewed from the wood-concrete composite element.

1. A plug for use in a wood-concrete composite element, comprising:
the plug is provided for placing onto the head of a screw which is provided for screwing into a wooden element of the wood-concrete composite element,
wherein the plug is designed to at least partially engage around a periphery of a screw head, and/or in that the plug is designed to engage with a drive formation of the screw.

2. A plug according to claim 1, wherein the plug is designed to at least partially engage around a periphery of a screw head, wherein the plug has a cutout with an at least partially undercut periphery for receiving the periphery of the screw head.

3. A plug according to claim 2, wherein the plug has, in a wall of the cutout, a circumferential predetermined breaking edge.

4. A lug according to claim 3, wherein the predetermined breaking edge is adjacent to the undercut periphery for receiving the periphery of the screw head.

5. A plug according to claim 1, wherein the plug is designed to engage with a drive formation of the screw, wherein the plug has a stud which can be plugged into a drive formation of the screw.

6. A plug according to claim 1, wherein the plug has a length which is dimensioned in such a way that the plug in the finished wood-concrete composite element extends as far as a top side of a concrete layer of the wood-concrete composite element.

7. A plug according to claim 1, wherein the plug is formed in one piece and from an elastic material, in particular rubber or rubber-like material.

8. A plug according to claim 1, wherein the plug is of cylindrical or truncated-cone-shaped design.

9. A plug according to claim 8, wherein a top side of the plug is arranged obliquely with respect to a bottom side, in particular in that the plug has the form of an obliquely cut circular cylinder or of an obliquely cut circular truncated cone.

10. A plug according to claim 1, wherein the plug has a passage opening or a cutout, wherein, when the plug has been placed onto a screw, a drive formation of the screw is accessible through the passage opening or through the cutout.

11. A plug according to claim 10, wherein a stopper or a cap is provided, in order to close the passage opening or the cutout.

12. A plug according to claim 10, wherein an inlet opening of the passage opening or of the cutout is closed by means of a predetermined breaking point and/or a membrane.

13. A plug according to claim 1, wherein the plug is constructed as a hollow body.

14. A plug according to claim 1, wherein at least one marking lug or gripping portion proceeds from a top side of the plug and extends beyond a top side of the concrete layer in the installed state.

15. A plug according to claim 1, further including a screw for screwing into the wooden element of the wood-concrete composite element, wherein the shank of the screw, proceeding from the screw head, tapers in the direction of the screw tip at least in a portion arranged in the concrete layer of the wood-concrete composite element.

16. A plug according to claim 1, wherein an outer diameter of the shank of the screw in a portion of the shank of the screw that is arranged in the concrete layer of the wood-concrete composite element is greater than or equal to an outer diameter of a portion of the shank of the screw that is arranged in the wooden element of the wood-concrete composite element.

17. A wood-concrete composite element, in particular a wood-concrete composite ceiling, comprising:
a wooden element, at least one screw screwed into the wooden element,
a plug according to claim 1 placed onto a screw head of the screw, and
a concrete layer which rests on a top side of the wooden element and extends beyond a head of the screw,
wherein the plug is fastened to the head of the screw, wherein an outer diameter of the plug as far as a top side of the plug is greater than or the same size as an outer diameter of the screw head, and
wherein the plug extends as far as a top side of the concrete layer.

18. A wood-concrete composite element according to claim 17, wherein a marking lug or a gripping portion proceeds from a top side of the plug, said top side facing away from a head of the screw, and extends beyond a top side of the concrete layer.

19. A wood-concrete composite element according to claim 17, wherein the plug has a passage opening or a cutout, wherein a drive formation of the screw is accessible through the passage opening or the cutout, and wherein an inlet opening of the passage opening or cutout, which is arranged in the top side of the plug, is arranged flush with a top side of the concrete layer.

20. A wood-concrete composite element according to claim 19, wherein the inlet opening of the passage opening or cutout is closed by means of a cap or a stopper.

21. A wood-concrete composite element according to claim 19, wherein the inlet opening of the passage opening or cutout is provided with a predetermined breaking point or a membrane.

22. A method for producing a wood-concrete composite element according to claim 17, including the following steps: screwing at least one screw into a top side of a wooden element, in particular of a wooden ceiling, of the wood-concrete composite element, placing a plug onto a screw head of the at least one screw and applying a concrete layer to a top side of the wooden element, such that the concrete layer extends as far as a top side of the plug.

23. A method for dismantling a wood-concrete composite element according to claim 17, including the following steps: unscrewing at least one screw from the wooden element of the wood-concrete composite element after the plug has been removed from the concrete layer and from the screw head of the screw, unscrewing the at least one screw from the wooden element and simultaneously removing the plug from the concrete layer or unscrewing the at least one screw through the passage opening of the plug and then removing the plug from the concrete layer and, after the screw has been unscrewed and the plug has been removed from the concrete layer, separating the concrete layer from the wooden element.
